(19) United States
(12) Patent Application Publication
(10) Pub. No.: US 2012/0090086 A1
(43) Pub. Date: Apr. 19, 2012

(54) TOILET ADAPTABLE WHEELCHAIR AND METHOD OF USE

(76) Inventors: Paul Melone, JR., Struthers, OH (US); Tammy Melone, Struthers, OH (US)

(21) Appl. No.: 12/905,052

(22) Filed: Oct. 14, 2010

(51) Int. Cl. A47K 11/06; B62M 1/14

(52) U.S. Cl. 4/480; 280/250.1

(57) ABSTRACT

A toilet adaptable wheelchair comprising a wheelchair including a set of standard features comprising a back rest, a seat, a pair of arm rests, a pair of wheels, a set of foot bars, a set of foot rests, a plurality of side bars and a pair of side panels. The toilet adaptable wheel chair further comprises a cutout within a central portion of the seat beneath where a person sits, a plurality of lifts coordinating with the plurality of side bars, where the plurality of lifts raise and lower the seat, a control panel to activate the plurality of lifts; and a chute secured beneath the cutout, wherein the chute directs substances which pass through the cutout into a toilet to enable the person to use the toilet without leaving the toilet adaptable wheelchair.

### BACKGROUND OF THE INVENTION

1. Field of the Invention

The present invention relates to a wheelchair adapted to fit above a toilet to enable a wheelchair bound person to use a toilet without assistance or with limited assistance.

2. Description of Related Art

Wheelchairs are common devices used by individuals who may have difficulty with ambulation. Many people may require the use of a wheelchair, whether for medical conditions, physical limitations, fatigue or a vast number of other reasons. Some individuals are able to move and control the wheelchair independently, while others may require assistance for use from a nurse or caretaker. Some individuals may require assistance maneuvering the chair from location to another when unable to control the chair on their own.

A common challenge of many wheelchair users is learning how to use a restroom. Many times, the wheelchair bound person may use a catheter or wear a diaper, so assistance is needed when changing the associated equipment. Other individuals often require assistance from the caretaker to use the toilet. The caretaker must lift the person from the wheelchair and place them upon the toilet seat. Many times the wheelchair bound person is unable to hold themselves up over the toilet, thus the caretaker must brace them and support their weight during bathroom use. This process can be tiring and time consuming for the caretaker and embarrassing for the wheelchair user.

It would be beneficial in the art to provide a device to better enable a wheelchair bound person to use the restroom. It would also be desirable to provide a device which eliminates the task of a caretaker having to hold the wheelchair bound person above a toilet, thus providing less embarrassment to the wheelchair user and relief to the caretaker from one of their duties.

### SUMMARY OF THE INVENTION

In view of the foregoing disadvantages inherent in the prior art, the general purpose of the present disclosure is to provide a toilet adaptable wheelchair comprising a wheelchair including a set of standard features comprising a back rest, a seat, a pair of arm rests, a pair of wheels, a set of foot bars, a set of foot rests, a plurality of side bars and a pair of side panels. The toilet adaptable wheel chair further comprises a cutout within a central portion of the seat beneath where a person sits, a plurality of lifts coordinating with the plurality of side bars, where the plurality of lifts raise and lower the seat, a control panel to activate the plurality of lifts; and a chute secured beneath the cutout, wherein the chute directs substances which pass through the cutout into a toilet to enable the person to use the toilet without leaving the toilet adaptable wheelchair.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a toilet adaptable wheel chair in accordance with an exemplary embodiment of the present invention;

FIG. 1A depicts a chute used in conjunction with the wheel chair of the present invention; and

FIG. 2 depicts a top side view of a seat for a toilet adaptable wheel chair in accordance with an exemplary embodiment of the present invention.

Like reference numerals refer to like parts throughout the description of several views of the drawings.

### DETAILED DESCRIPTION OF THE DRAWINGS

The present invention relates to a wheelchair adapted to fit above a toilet to aid a wheelchair bound person when using a restroom. The toilet adaptable wheelchair helps to relieve nurses or other caretakers of some duties associated with caring for patients unable to use the restroom without assistance. The toilet adaptable wheelchair is a wheeled mobility device with a removable seat including a cutout section. The user is wheeled into position above the toilet bowl. A set of hydraulic lifts raise or lower the user above the toilet bowl to attain their optimal position. Through the cutout section, the user may expel their solid or liquid waste into the toilet, without assistance by the caregiver. The toilet adaptable wheelchair allows the user to maintain their dignity and pride while using the restroom, because the user may use the restroom unassisted or with less assistance than with conventional wheelchairs.

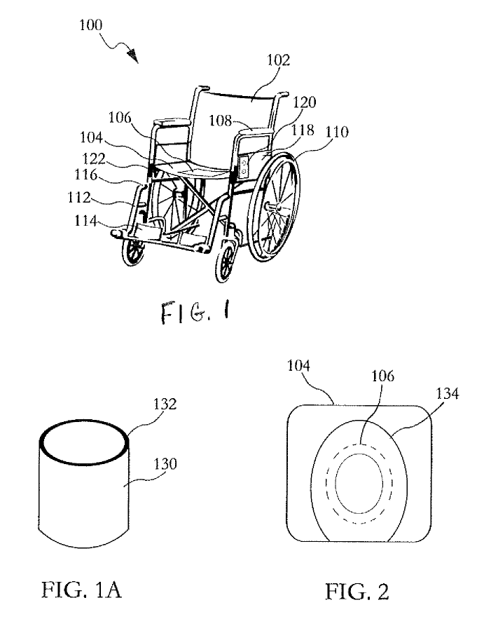

Turning now descriptively to the drawings, referring to FIG. 1, a perspective view of a toilet adaptable wheel chair (100) is shown in accordance with an exemplary embodiment of the present invention. The toilet adaptable wheelchair (100) may comprise a set of standard features commonly associated with a wheelchair, for example a back rest (102), a seat (104), a pair of arm rests (108), a pair of wheels (110), a set of foot bars (112), a set of foot rests (114), a plurality of side bars (116) and a pair of side panels (118). The toilet adaptable wheelchair (100) fails to include a set of cross bars as normally used with a standard wheelchair. The set of cross bars are removed so that the toilet adaptable wheelchair (100) may easily wheel above a toilet.

Accordingly, a cutout (106) may be provided within a central portion of the seat (104), directly below where a person sits. The cutout (106) provides an opening or hole within the seat (104) of the toilet adaptable wheelchair (100), to allow items and/or fluids to pass through the seat (104). Along each of the plurality of side bars (116) may be a plurality of lifts (122). The plurality of lifts (122) raise and lower the person sitting on the seat (104). The plurality of lifts (122) may be hydraulic lifts or shocks, electronically controlled by a control panel (120) attached to one of the side panels (118). The control panel (120) may have a set of buttons set to send control signals to the plurality of lifts (122) to work together to lift the seat (104) against the plurality of side bars (116) all at the same time. The control panel (120) may be rechargeable, electrically or battery operated, providing functionality in a variety of environments. A chute (130), shown in FIG. 1A may be removably secured beneath the cutout (106). The chute (130), in one particular embodiment, includes a tubular member to direct where substances pass through the cutout (106). The chute (130) may include a rim (132) attached to an upper edge to better brace the chute (130) below the seat (104) and cutout (106). The rim (132) may include rubber tubing removable for cleaning and sterilization.

To use the toilet adaptable wheelchair (100), the user may sit on the seat (104) above the cutout (106). The user or a caregiver may then raise or lower the seat (104) by using the control panel (120) and activating the plurality of lifts (122). Once the user is at an ideal height, they may then wheel themselves over a toilet bowl. The user should keep in mind that the chute (130) is beneath the seat (104), and should adjust their height to allow for the chute (130) to fit over the rim of the toilet bowl. If any height adjustments are necessary, after the seat (104) is over the toilet bowl, the user may adjust the seat (104) accordingly. After the user is in position, over the toilet, with the chute (130) directed within the toilet bowl, the user may then use the restroom as necessary. The chute (130) may ensure that all of the solid and liquid waste passes into the toilet bowl. Between uses, the chute (130) may be removed for cleansing and sterilization. The toilet adaptable wheelchair (100) enables the user to use the toilet unassisted or with less assistance because the user may secure the wheelchair and adjust themselves over the toilet for use.

Referring now to FIG. 2 a top view of the seat (104) for the toilet adaptable wheel chair (100) is shown in accordance with an exemplary embodiment of the present invention. The seat (104) may be equipped with a cushion (134) or pad to provide greater comfort to the user while sitting on the seat (104). The cushion (134) may be removable and may serve as an optional accessory for the toilet adaptable wheelchair. The chute may snap below the cushion (134) to create a solid piece for the flow of any substances into the toilet. With the advantages of the toilet adaptable wheelchair, a user may receive better peace of mind when independently using a toilet and may be more confident knowing that they are able to maintain their dignity and pride while using the restroom.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A toilet adaptable wheelchair comprising:
a wheelchair including a set of standard features comprising a back rest, a seat, a pair of arm rests, a pair of wheels, a set of foot bars, a set of foot rests, a plurality of side bars and a pair of side panels;
a cutout within a central portion of said seat beneath where a person sits;
a plurality of lifts coordinating with said plurality of side bars, where said plurality of lifts raises and lower said seat;
a control panel to activate said plurality of lifts; and
a chute secured beneath said cutout, wherein said chute directs substances passing through said cutout into a toilet to enable said person to use said toilet without leaving said toilet adaptable wheelchair.

2. The toilet adaptable wheelchair of claim 1, wherein said seat includes a cushion to enable said person to comfortably sit.

3. The toilet adaptable wheelchair of claim 1, wherein said control panel operates with a set of batteries.

4. A method of use for a toilet adaptable wheelchair comprising the steps of:
wheeling a person sitting upon a seat within said toilet adaptable wheelchair over a toilet;
adjusting said person above said toilet by raising or lowering said seat with a plurality of lifts attached to a plurality of side bars within said toilet adaptable wheelchair;
placing said seat directly above said toilet to centralize a cutout located beneath said person;
directing a chute attached below said cutout into a toilet bowl;
using said toilet by said person; and
enabling said chute to direct substances into said toilet bowl.

5. The method of using said toilet adaptable chute further comprising the step of removing said chute for cleansing after use.
